(19) United States
(12) Patent Application Publication
(10) Pub. No.: US 2016/0202169 A1
(43) Pub. Date: Jul. 14, 2016

(54) METHOD OF OPERATING A PARTICLE SENSOR AND EVALUATION OF THE RESULTS THEREOF

(71) Applicant: HYDAC FILTER SYSTEMS GMBH, Sulzbach/Saar (DE)

(72) Inventors: Joerg KLEBER, Neunkirchen (DE); Andreas WILHELM, Dillingen (DE)

(73) Assignee: Hydac Filter Systems GMBH, Sulzbach/Saar (DE)

(21) Appl. No.: 14/913,403

(22) PCT Filed: Aug. 20, 2014
(86) PCT No.: PCT/EP2014/002286

§ 371 Date: Feb. 22, 2016

(30) Foreign Application Priority Data
Sep. 3, 2013 (DE) 10 2013 014 670.4

(51) Int. Cl. G01N 15/10

(52) U.S. Cl. CPC G01N 15/1031; F03D 11/0091; G01N 2015/1062

(57) ABSTRACT

The invention concerns a method of operating a particle sensor and evaluation of a result. A method of operating a particle sensor and evaluation of the results thereof comprises at least the following method steps: determining the frequency of the particle occurrences by means of the particle sensor; and signalling the exceeding of a predefinable threshold value, determined from the maximum particle number detected per time interval.

The invention relates to a method for operating a particle sensor together with the evaluation of its results.

Such a method is used in accordance with the teaching of DE 10 2011 121 528 A1 for monitoring a fluid-carrying system, especially in the form of a hydraulic system, comprising the determination of the presence of particles in the fluid and/or the determination the degree of contamination by means of at least one device for detecting individual particles, such as a particle counting device. In such a method, the particle number and/or the degree of contamination is determined at each increment of time over a predefined period of time, wherein an increment count resultant from the particle number and/or the degree of contamination is summed up over the predefined period of time and, in the event of exceeding a predefined limit and/or the expiry of the specified period of time, a service requirement is issued.

Fluid-carrying systems are monitored with regard to contamination of the guided fluid with particles, such as oil in a hydraulic system, in wide range of application. From the number of particles determined by the device for detecting individual particles, the contamination level can be determined and output preferably online. Depending on the measured contamination or the determined contamination level, the fluid-carrying system can then be serviced or maintained. Regular servicing and maintenance, i.e. adequate service, is the prerequisite for lasting and reliable operation of a fluid-carrying system. To keep the operating costs for the fluid-carrying system as low as possible, the cost of the respective maintenance itself and the downtime of the system during the respective maintenance, as well as any subsequent repair of damages, must be kept low, i.e., the maintenance interval or the maintenance cycle must be chosen to be as long as possible.

The optimum maintenance interval depends not only on known properties of the fluid-carrying system, such as the construction of its components, but also on variable, more or less known operating conditions, so that the optimum maintenance interval until the need for carrying out service may be variable in its length. The particle counting devices used in known methods and devices for determining the respective degree of contamination are used to optimize the respective maintenance interval by issuing, in particular displaying, the respective degree of contamination. Hereby, the maintenance interval may sometimes be chosen to be too short, since even in the event of a singular, i.e. short-term, high contamination level, service is signaled as being required.

With the aid of the known method described above, the maintenance of the fluid-carrying system is determined in dependence on the contamination of the fluid occurring during operation of the system, which depends on the wear, operational changes, and the temperature, and corresponding service is output as being required, so that such service interval can preferably be initiated promptly.

The respective device for detecting individual particles may preferably be a particle counting device or a mesh blockage sensor or other contamination sensor, calibrated according to ISO 11171 or 11943 or by any other standard, and typically increments the number of particles or the corresponding increment count during operation of the fluid-carrying system, starting from zero. Such sensors are shown by way of example in DE 197 35 066 C1 and DE 102 47 353 A1.

The respective referenced increment counter is a function, in particular of the pollution class, for example, according to SAE AS 4059 or ISO 4406, or a quantitative representation of contamination as well as the temperature and is stored in the system as a formula or table. The corresponding counting rate depends on the contamination of the fluid with particles, such as on oil purity: At a low degree of contamination, such as for high oil purity, the counting speed is slow; at increasingly higher degree of contamination, such as for low oil purity, the counting increases. The respective counting device can be used as an online pollution sensor with so-called “wear counter” evaluation in the fluid-carrying system, such as in a hydraulic machine.

In the combined prior art, methods are known for the operation of particle sensors, in which the sensor issues a “square wave” output for each detected particle so that a switching output can connect through briefly (DE 197 35 066 C1). Another method solution is that the sensor outputs the number of detected particles via a digital communication interface and that the detected particles are differentiated by size and material type (DE 102 47 353 A1). Further, the information from the particle sensor can be processed and relayed by a separate additional electronic evaluation unit (DE 10 2011 121 528 A1).

In all the above-described methods for operating the various types of particle sensors, the sensor information obtained must generally be processed and relayed outside of the sensor. Typically, there is a connection to so-called oscillation monitoring systems, which are usually expensive, however, and often need to be acquired as they are not present in the base system. Alternatively, there is the possibility of additionally installing systems for data acquisition/processing/transmission, which in turn requires a separate “computing unit,” which is not only usually expensive to purchase, but also requires extra space along with wiring. An integration into the existing system controls requires changes to the control software, which is usually not possible due to warranty issues. Furthermore, it results in additional high test expenditures with associated costs to ensure reliable integration of sensor information into the respective system control on site.

Starting from this prior art, the object of the invention is to be able to apply the sensor signals obtained from a particle sensor into existing systems or existing structures according to the method in a simple manner without requiring additional computers or electronic evaluation units and without the need to modify existing software, such as control software. This object is achieved by a method for operating a particle sensor together with the evaluation of its results according to the configuration of features of claim 1 in its entirety.

The inventive method according to claim 1 is characterized by the following method steps:
determining the frequency of particle events by means of the particle sensor and
signaling the exceeding of a predefinable limit value, determined from the maximum of the detected number of particles per time interval.

Due to such inventive method steps, the particle sensor itself, i.e., independently, detects states that must be signaled and outputs at least one switching signal, which can be fed easily into existing systems or structures on site without the need for additional control or computing effort and without the need to modify existing software processes.

As described above, the particle sensor itself determines the frequency of occurring particle incidents. In doing so, the exceeding of a limit (maximum number of particles per time interval or per time increment) is signaled.

If such a method for operating a particle sensor is used, for example in a wind power plant, its system control itself has a number of “alarm inputs” that are relayed to an operator. Such inputs are present by default, and there are normally free inputs available in most cases, which can be used for the integration of the particle sensor. It is then possible without software modification to use the particle sensor integrated in such a way to signal its alarm information or warnings to the operator accordingly. The operator can then acknowledge or reset these messages and, depending on the significance of the signal, either take action immediately or, with numerous occurrences, at a later time and initiate appropriate measures, for example as part of a maintenance or service interval.

It has proved particularly advantageous to define several time intervals in sequences with increasing time, while defining an associated maximum number of particles for each time interval. In this case, a first time interval or time increment in the detection can cover a range of minutes, a second time interval can cover a range of 24 hours, and a third time interval can cover the range of days, for example, the range of one week. Each time interval specified by a user is then assigned a predefined maximum particle number, above which a respective independent alarm is triggered, which can be relayed to said system control with its plurality of alarm inputs, including in the form of a so-called parameterizing menu within the scope of a computer and system control.

In another particularly preferred embodiment of the method according to the invention, it is provided that the particle sensor itself determines the maximum occurring particle number per time interval through self-learning in a learning phase and uses it to calculate an individual alarm threshold. This “self-learning” method is applicable only if there is no damage to the system presently or the operational capability of the fluid circuit to be monitored is ensured.

For detecting particle contamination in the range of transmission solutions for wind power plants, so-called inductive metal particle sensors have proven to be particularly suitable. Such inductive particle counters include at least one field coil for generating a magnetic field at least partially covering a fluid flow, wherein a sensor coil, which is connectable to an evaluation device, for example in the wind power plant, which is used to detect the presence of a particle in the fluid flow by means of the signal induced in the sensor coil. If the device, as shown in DE 10 2006 005 956 A1, includes at least a first and a second sensor coil, wherein said two sensor coils are wound in opposite directions, the sensitivity with respect to the particles to be detected can be increased and even smaller particles having a size of 50 to 100 μm can be easily detected.

The method for operating a particle sensor according to the invention is explained in greater detail below based on the drawing. In the figures:

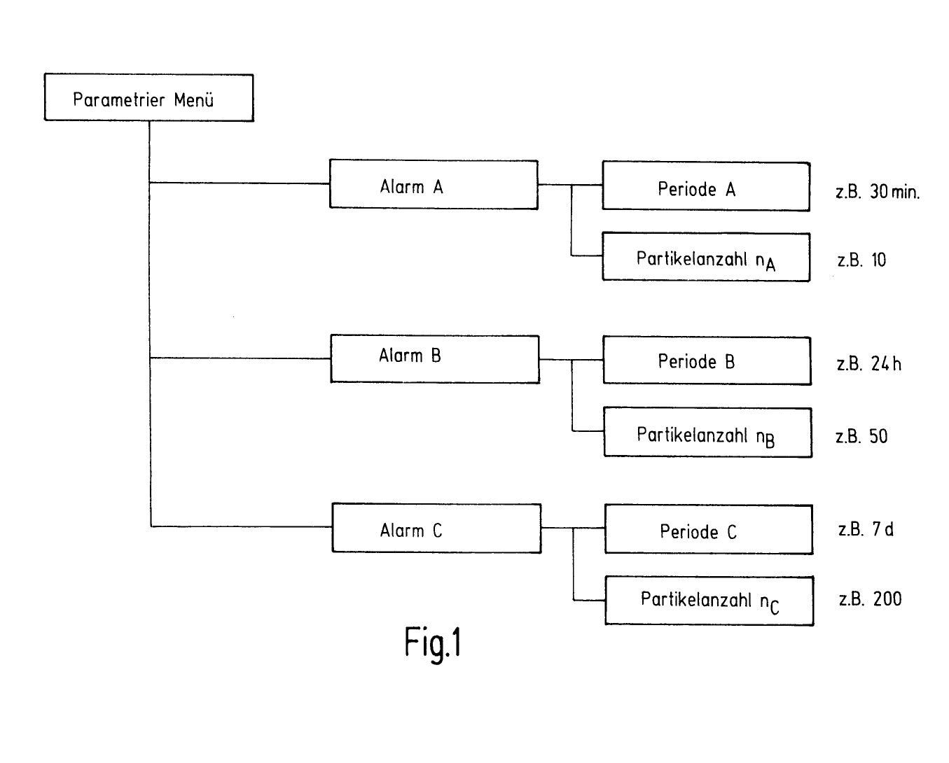

FIG. 1 is a type of menu overview concerning the setting of the time intervals and the maximum number of particles;

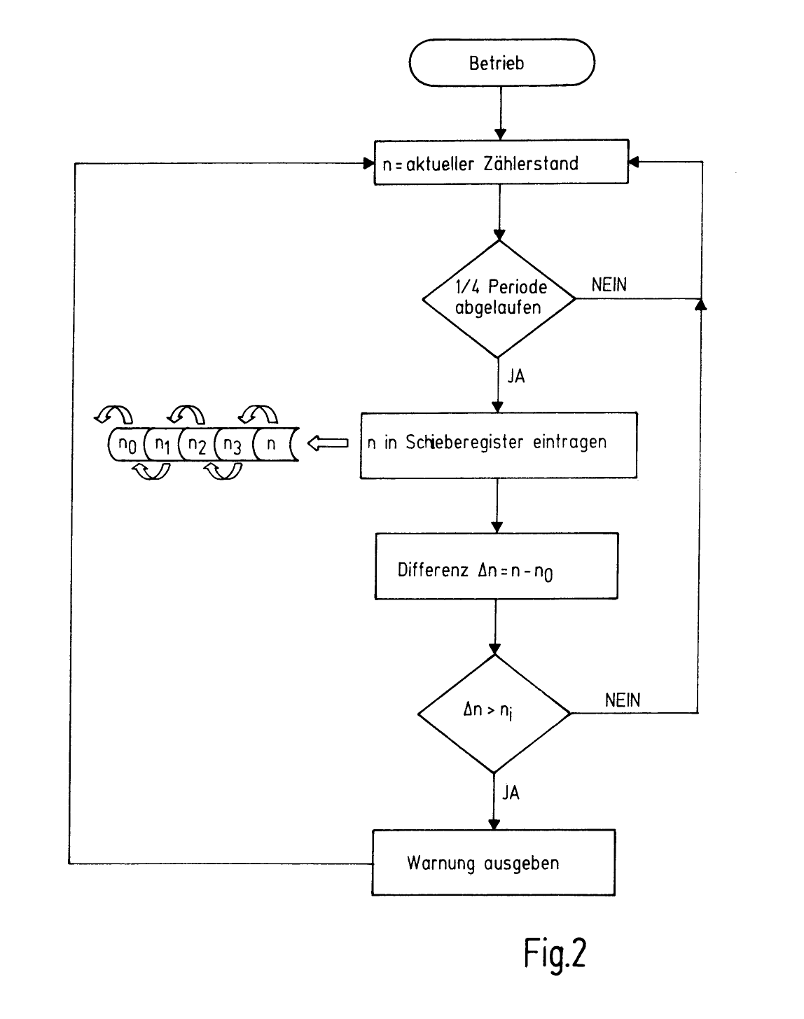

FIG. 2 shows, in the form of a flow chart, the possible method process for a particle sensor when used in the method according to the invention.

The method for operating a particle sensor according to the invention, along with the evaluation of its results, is explained below in greater detail. The particle sensor itself is not shown in detail; preferably, however, an inductive metal particle sensor should be used, which is shown by way of example in DE 10 2006 005 956 A1. The method according to the invention is characterized in particular in that the particle sensor determines the frequency of particle events and signals the exceeding of a predefinable limit value, determined from the maximum of the detected number of particles per time interval.

As shown particularly in FIG. 1, several time intervals, which are labeled with periods A, B, and C, are defined in a sequence of increasing time and each time interval, A, B, C, is assigned a maximum particle number. For instance, period A should cover, for example, a period of 30 min and the maximum number of particles n_{A} should be set to 10 particles. The period B should cover 24 hours (h) with a maximum particle number n_{B} of 50. The period C covers 7 days (d), i.e., one week, with a set maximum number of particles n_{C} of 200. All specified time intervals, A, B, and C, are given only by way of example; Other time periods can be used instead and the maximum number of particles can be different from those specified above.

If the metal particle sensor, which preferably operates with an inductive measuring method, detects that the predefined limits for the periods, A, B, and C, as well as the respective particle numbers, n_{A}, n_{B}, n_{C}, are exceeded, an alarm A, an alarm B, or alarm C, assigned to each time interval, A, B, C, is output, which, according to the illustration of FIG. 1, is relayed to a so-called parameterizing menu to feed, in this manner, the respective alarm message for the operator into an “alarm input” of a system controller, not shown, for example, in a wind power plant.

As illustrated, in the event of exceeding the respective predefinable limit for the maximum particle number, n_{A}, n_{B}, n_{C}, assigned to each time interval, A, B, C, an individual alarm signal, identifiable as such, alarm A, alarm B, and alarm C, is output.

The specified alarm levels, A, B, C, can be further supplemented by alarm messages D, etc. (not shown); furthermore, any combinations of the individual alarms, A, B, C, are possible, for example, in the combination of alarm A with alarm B or alarm A with alarm C etc.

Both, the length of the time intervals, A, B, C, as well as the maximum number of particles to be detected can be specified by the user of the method.

In a further development of the method according to the invention, it can be provided that the particle sensor uses a computer-aided learning phase to independently determine the maximum occurring particle number, n_{A}, n_{B}, n_{C}, per time interval, A, B, C, and independently generates from it a threshold value (e.g., a factor of 1.5) for the alarm signal output. The duration of the adaptation for the respective learning period can also be adjusted accordingly by the user. For this purpose, the limit values entered by the user as a starting value can be used during the learning phase. The successful completion of a learning phase can be signaled on the respective switching output.

A learning phase is successful if the determined limit values are within predefined limits. In this manner, the “learning” of an error state as the normal state can be avoided. This is generally the case when damage is already present with high particle generation, which interferes with the sensor signal.

Having said that, FIG. 2 is intended to illustrate an operational process for the sensor by way of example. The monitoring for maximum particle number specified there runs in parallel for the different periods, A (e.g., 30 min), B (e.g. 24 h), and C (e.g., 7 d). During operation of the particle sensor, the current count n of particle contamination is detected over these periods, A, B, C. Once ¼ of the specified periods, A, B, C, or time intervals has elapsed, the determined value n is entered into a shift register, which denotes the individual detected values with n₀, n₁, n₂, n₃, etc. If, as mentioned, ¼ of period has not yet elapsed, the current counter method continues. Values read from the shift register are then used to determine the difference Δn=n−n₀. If the resulting value Δn>nᵢ, a warning alarm, A, B, C, is output, where nᵢ is the maximum allowable number of particles for a period i, i.e., n_{A} for period A, n_{B} for period B, and n_{C} for period C. If the reference value determination Δn≦nᵢ, the current count determination n is continued. A through-connection of, for example, one second may be provided for the switching output to which the warning is output. Thereafter, no further warning is output for a dead time of, for example, one period. The purpose of the aforementioned dead time is to not output an occurring warning repeatedly. This could otherwise be the case due to the shift register.

1. A method for operating a particle sensor together with the evaluation of its results, comprising at least the following method steps:
Determining the frequency of particles events by means of the particle sensor and
Signaling the exceeding of a predefinable limit value, determined from the maximum of the detected number of particles per time interval.

2. The method according to claim 1, characterized in that several time intervals (A, B, C) are defined in a sequence of increasing time and that each time interval (A, B, C) is assigned a predefined maximum number of particles (n_{A}, n_{B}, n_{C}).

3. The method according to claim 1, characterized in that a first time interval (A) is predefined in the range of minutes (min), a second time interval (B) in the range of hours (24 h), and a third time interval (C) in the range of days (d).

4. The method according to claim 1, characterized in that, in the event of exceeding the respective predefinable limit value (n_{A}, n_{B}, n_{C}) and each time interval (A, B, C), an individual alarm signal, identifiable as such (alarm A, B, C), is output.

5. The method according to claim 1, characterized in that both the length of the time intervals (A, B, C), as well as the maximum number of particles to be detected, are predefinable by the user of the method.

6. The method according to claim 1, characterized in that the particle sensor uses a computer-based learning phase to independently determine the maximum occurring particle number (n_{A}, n_{B}, n_{C}) per time interval (A, B, C) and generates from it a threshold value for the alarm signal output.

7. The method according to claim 6, characterized in that the duration of the learning phase is predefined by the user.

8. The method according to claim 6, characterized in that the limit values predefined by the user as a start value are used during the learning phase.

9. The method according to claim 6, characterized in that the successful completion of a learning phase is signaled.

10. The method according to claim 6, characterized in that the learning phase is detected as being successfully completed if the determined limit values are within predefined maximum values.

11. The method according to claim 1, characterized in that it is used to monitor the operability of transmissions, for example in wind power plants, and that inductive metal particle sensors are used as particle sensors.
